(19) United States
(12) Patent Application Publication
(10) Pub. No.: US 2014/0345455 A1
(43) Pub. Date: Nov. 27, 2014

(54) Thermal Barrier for a Piston

(71) Applicant: EcoMotors, Inc., Allen Park, MI (US)

(72) Inventors: Peter Hofbauer, West Bloomfield, MI (US); Diana Brehob, Dearborn, MI (US)

(73) Assignee: EcoMotors, Inc., Allen Park, MI (US)

(21) Appl. No.: 14/284,440

(22) Filed: May 22, 2014

Related U.S. Application Data
(60) Provisional application No. 61/826,062, filed on May 22, 2013.

(51) Int. Cl. F02F 3/00

(52) U.S. Cl. CPC F02F 3/0015; F02F 2200/00
USPC 92/208; 29/888.04

(57) ABSTRACT

It is important to maintain the temperature in the ring pack area of the piston of an internal combustion engine below about 270° C. to maintain proper ring function and lubrication. Disclosed is a piston with a heat barrier groove between the piston top and the ring pack and a method to construct such a piston. The heat barrier groove extends inwardly toward the center of the piston a greater distance than the compression ring grooves. In one embodiment, a low thermal conductivity material is placed in the inner portion of the heat barrier groove and a split ring is place in the outer portion. In another embodiment, a gas is provided in the inner portion and the split ring is welded to the piston so that the inner portion of the heat barrier groove is sealed, i.e., welding at the upper and lower edges and at the gap.

### FIELD

The present disclosure relates to reducing temperature in the ring pack of a piston.

### BACKGROUND

Maintaining the functionality of the compression rings of a piston can be hampered if the temperature is too high. A piston design in which the ring pack region is protected from high temperature is desired.

### SUMMARY

To overcome at least one problem in the prior art, a piston assembly is disclosed that has a piston having a piston top, a generally cylindrical skirt, and a ring pack region in the cylindrical body having a first compression ring groove, a second compression ring groove, and a heat barrier groove extending inwardly farther than the compression ring grooves. The piston assembly also has a first compression ring disposed in the first compression ring groove, a second compression ring disposed in the second compression ring groove, and a split ring disposed in an outer portion of the heat barrier groove. The split ring is welded to a corner of the heat barrier groove. Some embodiments include a ceramic ring having low thermal conductivity is disposed in an inner portion of the heat barrier groove. The ceramic ring may be two arcs that are held in place by the split ring. Alternatively, a low thermal conductivity material disposed in an inner portion of the heat barrier groove. The low thermal conductivity material is one of a thermally-sprayed ceramic powder and a foam. In some embodiments, the outer portion of the heat barrier groove is thicker than an inner portion of the heat barrier groove. The thickness of the inner portion of the heat barrier groove is less than a predetermined thickness. The predetermined thickness is a thickness at which convective currents are absent at the operating conditions anticipated in the piston.

Also disclosed is a method to fabricate a piston assembly including: forming a piston having a piston top and a cylindrical side wall; providing a compression ring groove in the side wall of the piston; providing a heat barrier groove in the side wall of the piston with the heat barrier groove closer to the piston top than the compression ring groove; placing a split ring in an outer portion of the heat barrier groove; and affixing the split ring to a corner of the heat barrier groove proximate the cylindrical side wall of the piston. The method may further include affixing the split ring to a second corner of the heat barrier groove proximate the cylindrical side wall of the piston and sealing up the gap in the split ring. In some embodiments, the split ring is affixed to the heat barrier groove via welds and the gap is sealed by a weld. Alternatively, a low thermal conductivity material is placed in an inner portion of the heat barrier groove. The cylindrical side wall of the piston is ground to remove any protrusions that extend outwardly from the cylindrical side wall.

### BRIEF DESCRIPTION OF THE DRAWINGS

FIG. 1 is a cross section of a piston according to an embodiment of the present disclosure;

FIG. 2 is a portion of the piston illustrated in FIG. 1;

FIGS. 3 and 4 are portions of a piston according to embodiments of the present disclosure;

FIGS. 5 and 6 are views of the split ring;

FIG. 7 is a view arcs of low thermal conductivity material that can be placed in the thermal barrier groove; and

FIG. 8 is a flowchart illustrating processes involved in various embodiments of assembling the piston.

### DETAILED DESCRIPTION

As those of ordinary skill in the art will understand, various features of the embodiments illustrated and described with reference to any one of the Figures may be combined with features illustrated in one or more other Figures to produce alternative embodiments that are not explicitly illustrated or described. The combinations of features illustrated provide representative embodiments for typical applications. However, various combinations and modifications of the features consistent with the teachings of the present disclosure may be desired for particular applications or implementations. Those of ordinary skill in the art may recognize similar applications or implementations whether or not explicitly described or illustrated.

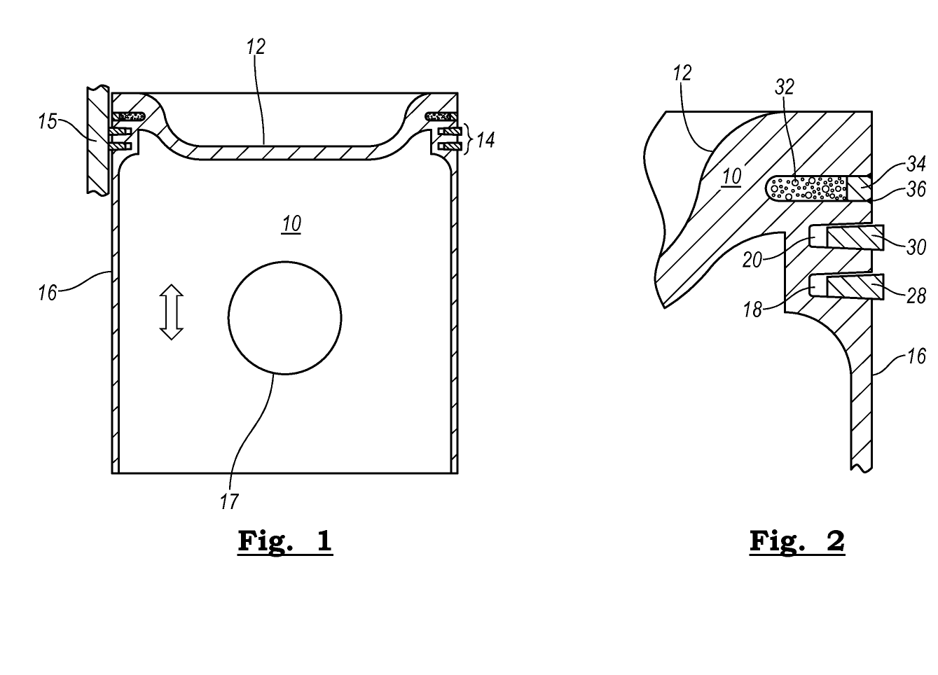

At least one problem in the prior art is overcome by a piston 10 for an internal combustion engine as shown in cross section in FIG. 1. A top 12 of the piston 10 is heated by the flame in the combustion chamber. Measures can be taken to prevent piston top 12 from melting, which is the subject of other disclosures. It is crucial for the temperature of a ring pack region 14 to be kept below about 270° C. to prevent ring sticking due to lubricant breakdown and to continue to lubricate the outside edges of the piston rings that ride on the cylinder liner. A skirt 16 of piston 10 is substantially cylindrical.

A portion of piston 10 is shown in FIG. 2. Piston 10 has grooves 18 and 20 into which compression rings 28 and 30 are disposed, respectively. Compression rings 28 and 20 are keystone rings. These are shown by way of example and are not intended to be limiting. The number of compression rings may be greater or fewer than shown in FIGS. 1-4 and the rings may be rectangular, stepped, keystone or any suitable cross section. An additional groove, a heat barrier groove, is provided above groove 20. The heat barrier groove extends inwardly a greater distance than grooves 18 and 20 to provide a more robust thermal barrier, particularly from heat transfer from the center of piston top 12, which is the hottest portion of the piston. In the example in FIGS. 1 and 2, an interior portion of the groove is filled with a low thermal conductivity material. Any suitable material may be used, including, but not limited to: a thermally-sprayed, sintered, powdered, or foam material made of ceramic or metal.

The heat barrier groove weakens piston 10. Piston 10 can be designed to withstand the imposition of the groove. Also to overcome the impact of such a groove, a split ring 34 may be placed in an exterior portion of the groove. In the embodiment in FIGS. 1 and 2, ring 34 is welded at the lower edge to cause it to stay in place, shown as a weld bead 36. Ring 34 provides support to piston 10 at an outer edge as well as providing stability for the low thermal conductivity material in the inner portion of the heat barrier groove.

In an alternative embodiment (not illustrated herein), the heat barrier groove may slope inwardly sloping toward the wrist pin hole (element 17 in FIG. 1). In such an embodiment, the split ring that that is placed in the outer portion of the heat barrier groove has a cross section of a parallelogram.

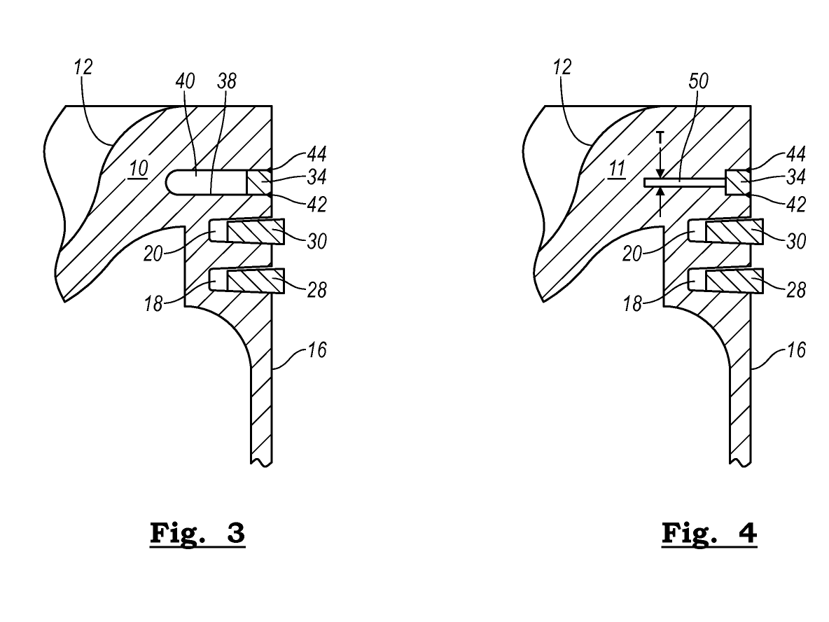

Referring now to FIG. 3, a gas is provided in a heat barrier groove 38. The gas can be air or other gas at ambient pressure or reduced pressure. In the embodiments in FIGS. 3 and 4, split ring 34 is welded to piston 10 at both the upper and lower surfaces of ring 34. To prevent oil from entering groove 38 and thereby affecting the thermal characteristics of piston 10, ring 34 seals groove 40 off from outside piston 10.

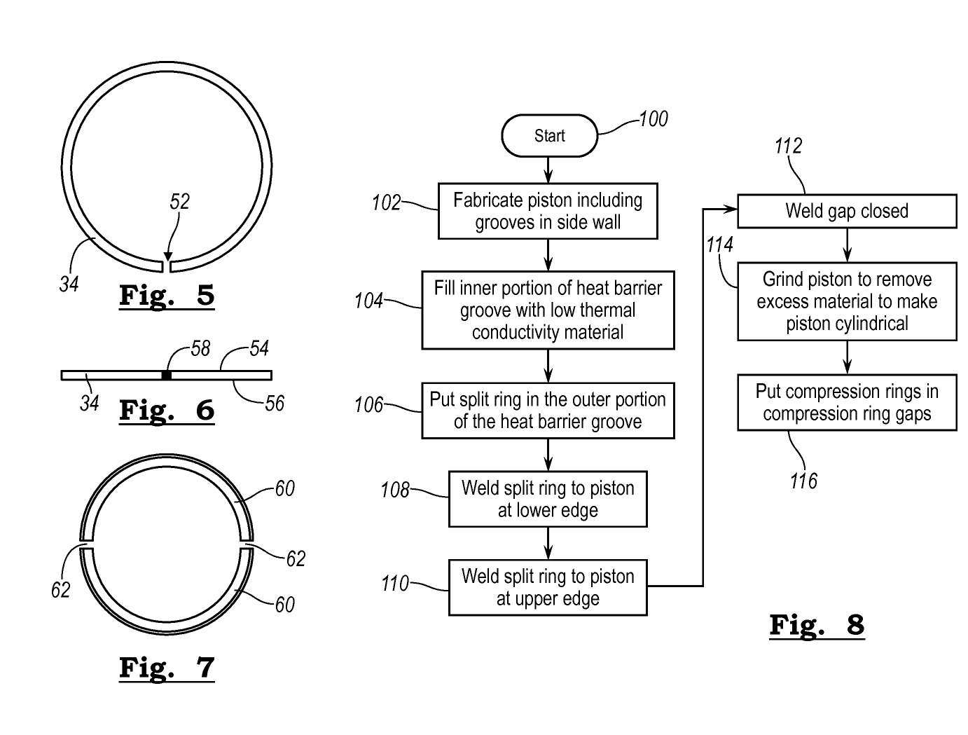

Referring now to FIGS. 5 and 6, split ring 34 is shown having a gap 52. Gap 52 facilitates insertion of ring 34 in groove 40 (of FIG. 3). Gap 52 may be welded closed to seal off the interior portion of groove 40. Referring to FIG. 6, ring 34 is welded at an upper edge 54 to the piston (not shown), at a lower edge 56 to the piston, and to close gap 52 (of FIG. 5) is closed off by weld bead 58.

An alternative embodiment is shown in FIG. 4, a piston 11 in which the interior portion of a groove 50 is narrow and having a predetermined thickness, T. The thickness is determined so that natural convection is prevented or nearly prevented over the range of operating conditions anticipated. That is, the thickness is such that heat transfer from the upper to the lower portions of groove 50 are dominated by conductive heat transfer with some radiative heat transfer, but substantially no convection. As air (or other gas) sealed in groove 50 has a much lower thermal conductivity than the parent metal of the piston, the presence of groove 50 serves as a thermal barrier to heat transfer.

As described above in regards to embodiments associated with FIGS. 1 and 2, a material is placed in the inner portion of the groove and cures or otherwise hardens in place. In another embodiment, the material placed in the inner portion of the groove is formed outside of the groove and then placed in the groove. Such a material is formed in two or more pieces, such as is shown in FIG. 7. Two 180° arcs can be placed in the inner portion of the heat barrier groove and then secured in the groove by any suitable method, including but not limited to: welding, brazing, pinning, gluing, and epoxying.

Referring to FIG. 1, piston 10 can reciprocates within a cylinder wall, a portion of which is shown as element 15. A gap exists between cylinder wall 15 and piston 10. Compression rings 28 and 30 spring outwardly and ride on cylinder wall 15. It is desirable to avoid anything extending outwardly from piston 10 beyond the cylindrical envelope of the skirt 16. Thus, the weld beads are ground off to the height of skirt 16.

A method to manufacture a piston, illustrated in FIG. 8, starts at 100. In 102, the piston is fabricated according to known techniques. Conventional grooves for compression rings are fabricated in step 102. Additionally, a heat barrier groove is formed in the piston, which is nonstandard. In block 104, the inner portion of the heat barrier groove is filled with a low thermal conductivity material, either with a rigid piece slid into the groove or by inserting material in the groove to set up in place. In block 106, the split ring is placed in the outer portion of the heat barrier groove. In block 108, the split ring is affixed to the piston at the edge of the heat barrier groove, i.e., around the circumference, by a weld, or other suitable process. In block 110, the split ring is affixed to the piston. In embodiments in which the inner portion of the heat barrier groove is sealed, the gap in the split ring is welded closed in block 112. In block 114, the piston is ground down in the region proximate the heat barrier groove so that excess material from the welds or other protrusions do not extend outwardly beyond the cylinder of the piston skirt. In block 116, the compression rings are installed as conventionally known.

Referring to FIG. 8, various embodiments do not include all of the blocks described. For example, some embodiments use a weld on only one edge of the split ring. The embodiments in FIGS. 3 and 4 do not use the process shown in block 104. Thus, various embodiments use a subset of the blocks shown in FIG. 8.

While the best mode has been described in detail with respect to particular embodiments, those familiar with the art will recognize various alternative designs and embodiments within the scope of the following claims. While various embodiments may have been described as providing advantages or being preferred over other embodiments with respect to one or more desired characteristics, as one skilled in the art is aware, one or more characteristics may be compromised to achieve desired system attributes, which depend on the specific application and implementation. These attributes include, but are not limited to: cost, strength, durability, life cycle cost, marketability, appearance, packaging, size, serviceability, weight, manufacturability, ease of assembly, etc. The embodiments described herein that are characterized as less desirable than other embodiments or prior art implementations with respect to one or more characteristics are not outside the scope of the disclosure and may be desirable for particular applications.

We claim:

1. A piston assembly, comprising:
a piston having a piston top, a generally cylindrical skirt, and a ring pack region in the cylindrical body having a first compression ring groove, a second compression ring groove, and a heat barrier groove wherein the heat barrier groove extends inwardly into the piston farther than the compression ring grooves;
a first compression ring disposed in the first compression ring groove;
a second compression ring disposed in the second compression ring groove; and
a split ring disposed in an outer portion of the heat barrier groove.

2. The piston assembly of claim 1 wherein the split ring is welded to a corner of the heat barrier groove.

3. The piston assembly of claim 1, further comprising: a ceramic ring having low thermal conductivity disposed in an inner portion of the heat barrier groove.

4. The piston assembly of claim 3 wherein the ceramic ring is comprised of at least two arcs that are held in place by the split ring.

5. The piston assembly of claim 1, further comprising: a low thermal conductivity material disposed in an inner portion of the heat barrier groove.

6. The piston assembly of claim 5 wherein the low thermal conductivity material is one of a thermally-sprayed ceramic powder and a foam.

7. The piston assembly of claim 1 wherein the outer portion of the heat barrier groove is thicker than an inner portion of the heat barrier groove.

8. The piston assembly of claim 7 wherein the thickness of the inner portion of the heat barrier groove is less than a predetermined thickness.

9. The piston assembly of claim 8 wherein the predetermined thickness is a thickness at which convective currents are substantially absent at the operating conditions anticipated in the piston.

10. A piston assembly, comprising:
a piston having a piston top, a generally cylindrical skirt, and a ring pack region in the cylindrical body having a compression ring groove, and a heat barrier groove extending inwardly farther than the compression ring groove;
a compression ring disposed in the compression ring groove; and
a split ring disposed in an outer portion of the heat barrier groove wherein the split ring is affixed to a corner of the heat barrier groove.

11. The piston assembly of claim 10 wherein the split ring is affixed to the heat barrier groove to form a seal so that fluids are substantially prevented from entering an inner portion of the heat barrier groove.

12. The piston assembly of claim 10, further comprising: a low thermal conductivity material disposed in an inner portion of the heat barrier groove.

13. The piston assembly of claim 10 wherein the outer portion of the heat barrier groove is thicker than an inner portion of the heat barrier groove.

14. The piston assembly of claim 13 wherein the thickness of the inner portion of the heat barrier groove is less than a thickness at which convective currents are absent at the operating conditions anticipated in the piston.

15. A method to fabricate a piston assembly, comprising:
forming a piston having a piston top and a cylindrical side wall;
providing a compression ring groove in the side wall of the piston;
providing a heat barrier groove in the side wall of the piston with the heat barrier groove closer to the piston top than the compression ring groove;
placing a split ring in an outer portion of the heat barrier groove; and
affixing the split ring to a corner of the heat barrier groove proximate the cylindrical side wall of the piston.

16. The method of claim 15 wherein the split ring is affixed to the heat barrier groove via a weld.

17. The method of claim 15, further comprising:
affixing the split ring to a second corner of the heat barrier groove proximate the cylindrical side wall of the piston; and
sealing up the gap in the split ring.

18. The method of claim 17 wherein the affixing and sealing are provided by welds.

19. The method of claim 15, further comprising: placing a low thermal conductivity material in an inner portion of the heat barrier groove prior to placing the split ring in the outer portion of the heat barrier groove.

20. The method of claim 15, further comprising: grinding the cylindrical side wall of the piston to remove any protrusions that extend outwardly from the cylindrical side wall.
